(19) United States
(12) Patent Application Publication
(10) Pub. No.: US 2011/0116791 A1
(43) Pub. Date: May 19, 2011

(54) INSTANTANEOUS INTERRUPTION MONITORING SYSTEM AND INSTANTANEOUS INTERRUPTION MONITORING PROGRAM

(75) Inventors: Seiichi Yasuda, Hokkaido (JP); Yasutomo Machida, Hokkaido (JP); Keiko Ida, Hokkaido (JP); Noriaki Nogami, Hokkaido (JP); Takaaki Yamada, Hokkaido (JP); Tomomi Ida, Hokkaido (JP)

(73) Assignee: HIT SYSTEM CO., LTD., Hokkaido (JP)

(21) Appl. No.: 12/993,295

(22) PCT Filed: Oct. 3, 2009
(86) PCT No.: PCT/JP2009/067280

§ 371 Date: Nov. 18, 2010

(30) Foreign Application Priority Data
Oct. 14, 2008 (JP) 2008-265670

(51) Int. Cl. H04B 10/08

(52) U.S. Cl. 398/21

(57) ABSTRACT

Provided are an instantaneous interruption monitoring system and an instantaneous interruption monitoring program for a computer incorporating a non-real time operating system (OS). Measurement results acquired from optical time domain reflectometers (OTDR) can be continuously stored and the occurrence of an instantaneous interruption can be reported in real time. The system includes an instantaneous interruption monitoring program that determines the occurrence of an instantaneous interruption on a communication line, records instantaneous interruption information, and reports the occurrence of an instantaneous interruption.

### TECHNICAL FIELD

The present invention relates to a technology for monitoring an instantaneous interruption which occurs in an optical cable, and particularly to an instantaneous interruption monitoring system and an instantaneous interruption monitoring program which continuously monitor the occurrence of an instantaneous interruption and report the same in real time.

### BACKGROUND ART

In recent years, an optical fiber communication network has provided an infrastructure essential to modern human life, ranging from communication, transmission, transportation and physical distribution to control of the flow rate of dams, water supply and sewerage and weather-related operations. However, it is extremely difficult to identify where and when each mechanical failure occurs, resulting in such technical problems as delay in the restoration of communication failure due to more difficult restoration operations than conventional analog communication techniques.

One of the conventional techniques for monitoring whether optical cable failure occurs or not is known as an optical fiber line monitoring system, as shown in Japanese Unexamined Patent Application Publication No. 2000-193555 (Patent Document 1). The optical fiber line monitoring system comprises a mobile station which allows an optical fiber measuring device to perform measurement in optical fiber lines via a communication network, and acquires and outputs a measurement result obtained in the measurement process.

### Prior Art Document

Patent Document

Patent Document 1: Japanese Unexamined Patent Application Publication No. 2000-193555

### OUTLINE OF THE INVENTION

### Problem to be Solved by the Invention

Nevertheless, monitoring systems using an optical time domain reflectometers (OTDR) including the invention described in Patent Document 1 unfortunately pose a technical problem, i.e. an inability to detect “instantaneous interruption.” Herein, instantaneous interruption is defined as unstable phenomenon in which communication line is disconnected in a moment (duration is normally below one second). As long as an optical transmission line is concerned, instantaneous interruption is caused due to mechanical strain in the optical transmission line under freezing and vibration conditions or due to a loosened connector at the optical connection component. Also, even when a field worker mistakenly pulls out the connector and immediately inserts it again, instantaneous interruption of hundreds of millisecond can be observed.

Accordingly, an instantaneous interruption can occur due to various factors including minor ones. So, if a location thereof can be identified, factors leading to crucial interruption can be eliminated in advance. Conversely, users would make a complaint of failure of system itself unless each location and cause thereof can be identified, thereby causing a problem with system reliability.

In this regard, a monitoring system using an OTDR identifies a location of failure by monitoring waveform data acquired from the OTDR in a conventional manner. Nevertheless, it is difficult to acquire a measurement result at a short time interval, because the OTDR itself requires long measurement duration. Consequently, a location of complete failure such as interruption can be found, but unstable failure such as instantaneous interruption, which occurs in a moment but will be eliminated immediately, cannot be identified in location.

While OTDRs whose measurement time is relatively short have been advantageously developed in recent years, computers for processing a measurement result used therewith are prone to a technical problem. Specifically, operating systems (OS) which are currently employed in general-purpose personal computers don't correspond to a real-time OS that executes processing in real time. Thus, it is difficult to monitor the occurrence of an instantaneous interruption while continuously storing an enormous amount of monitoring results obtained at a shortest time interval and report occurrence thereof in real time.

Furthermore, conventionally-existing computers incorporating a real time OS are unfortunately specialized computers designed for machinery control. Therefore, any user has a difficulty in coming by such computers and operability thereof is poor due to design for exclusively increasing a processing speed.

Also a conventional type of monitoring system normally assigns all processing on monitoring operations such as recording processing of monitoring results, reporting processing thereof to the administrator and response processing to a remote control device under a memory area controlled by a predetermined monitoring program. Consequently, if the memory area is fully occupied by the reporting processing or the response processing, it fails to perform the recording processing, resulting in a possible inability to acquire a monitoring result.

To solve the aforementioned problems, it is, therefore, one object of the present invention to provide an instantaneous interruption monitoring system and an instantaneous interruption monitoring program which is capable of continuously storing an enormous amount of measurement results obtained from an OTDR and reporting the occurrence of an instantaneous interruption in real time even in a computer incorporating a non-real time OS.

### Means for Solving the Problem

An instantaneous interruption monitoring system and an instantaneous interruption monitoring program according to the present invention correspond to an instantaneous interruption monitoring system which monitors an instantaneous interruption that occurs in an optical cable using an optical time domain reflectometer (OTDR) connected to said optical cable and an instantaneous interruption monitoring program which allows a computer to function as the instantaneous interruption monitoring system, respectively, said system comprising a software storing unit which stores a non-real time OS, a memory unit in which a measurement condition configuring table and a measurement result recording table are mapped to a memory area controlled by said instantaneous interruption monitoring program and in which an instantaneous interruption reporting table is mapped to a memory area controlled by said non-real time OS, a reference waveform data acquiring unit which acquires reference waveform data when no instantaneous interruption occurs from said OTDR, a measured waveform data acquiring unit which accordingly acquires measured waveform data at a predetermined time interval from said OTDR, a loss level calculating unit which calculates a loss level of said optical cable based on differential data between said reference waveform data and said measured waveform data, an instantaneous interruption occurrence determining unit which determines the occurrence of an instantaneous interruption by comparing said loss level calculated by the loss level calculating unit and a threshold for determining instantaneous interruption stored in said measurement condition configuring table, a measurement result recording unit which accordingly records a measurement result regarding said loss level on said measurement result recording table each time the instantaneous interruption occurrence determining unit determines whether an instantaneous interruption occurs or not, an instantaneous interruption information recording unit which records instantaneous interruption information regarding said instantaneous interruption on said instantaneous interruption reporting table when said instantaneous interruption occurrence determining unit determines the occurrence of an instantaneous interruption, and an instantaneous interruption occurrence reporting unit which reports the occurrence of an instantaneous interruption to a predetermined monitoring terminal based on said instantaneous interruption information recorded on said instantaneous interruption reporting table.

Also, an instantaneous interruption monitoring system in this invention may comprise, prior to supervision of an instantaneous interruption, a remaining capacity of a physical memory acquiring unit which acquires a remaining capacity of a physical memory incorporated in said instantaneous interruption monitoring system, a physical memory remaining capacity determining unit which determines whether a remaining capacity of a physical memory acquired by the physical memory remaining capacity acquiring unit is insufficient or not, a waveform data for self-diagnosis acquiring unit which acquires waveform data for self-diagnosis of the performance of said instantaneous interruption monitoring system from said OTDR before supervision of an instantaneous interruption starts, a noise removal processing unit which removes a noise component of said waveform data for self-diagnosis using plural types of noise filters to remove a noise component of said differential data, a measurement time calculating unit which calculates a measurement time obtained by adding a waveform data acquiring time required for acquiring said waveform data for self-diagnosis by said waveform data for self-diagnosis acquiring unit and a noise removing processing time required for removing a noise component of said waveform data for self-diagnosis by said noise removal processing unit for each of said noise filters, a measurement time determining unit which determines whether a shortest measurement time of said measurement times exceeds a threshold for selecting noise filter for selecting said noise filter or not, and a measurement condition changing unit which changes a measurement condition stored in said measurement condition configuring table when said physical memory remaining capacity determining unit determines that said physical memory remaining capacity is insufficient, or when said measurement time determining unit determines that said shortest measurement time exceeds said threshold for selecting noise filter.

In addition, an instantaneous interruption monitoring system in this invention may comprise an instantaneous interruption number calculating unit which calculates an instantaneous interruption number from the start of supervision when said instantaneous interruption occurrence determining unit determines that an instantaneous interruption occurs, an instantaneous interruption number determining unit which determines that the instantaneous interruption number calculated by the instantaneous interruption number calculating unit is two or more, or not, an instantaneous interruption occurrence point determining unit which determines whether a latest instantaneous interruption occurrence point is identical to a previous instantaneous interruption occurrence point or not when said instantaneous interruption number determining unit determines that said instantaneous interruption number is two or more, an instantaneous interruption duration calculating unit which calculates an instantaneous interruption duration in which said instantaneous interruption continues when said instantaneous interruption occurrence point determining unit determines that a latest instantaneous interruption occurrence point is identical to a previous instantaneous interruption occurrence point, an instantaneous interruption duration determining unit which determines whether the instantaneous interruption duration calculated by the instantaneous interruption duration calculating unit exceeds said threshold for selecting noise filter or not, and a noise filter changing unit which changes a noise filter to a higher-order noise filter when said instantaneous interruption duration determining unit determines that said instantaneous interruption duration exceeds said threshold for selecting noise filter.

### Advantageous Effect of the Invention

According to the present invention, even a computer incorporating an non-real time OS can continuously store an enormous amount of measurement results obtained from an OTDR, and report the occurrence of an instantaneous interruption in real time.

### BRIEF DESCRIPTION OF THE DRAWINGS

FIG. 1 is a block diagram showing one embodiment of overall configuration including an instantaneous interruption monitoring system according to the present invention.

FIG. 2 is a block diagram showing a memory area which is mapped to a memory unit of storing device in this embodiment.

FIG. 3 is a block diagram showing each component of arithmetic processing device in this embodiment.

FIG. 4 is a flowchart diagram showing an instantaneous interruption monitoring process and an instantaneous interruption reporting process executed by an instantaneous interruption monitoring program of this embodiment.

FIG. 5 is a flowchart diagram showing self-diagnosis processing in this embodiment.

FIG. 6 is a flowchart diagram showing loss level calculating processing in this embodiment.

FIG. 7 is a flowchart diagram showing noise filter changing processing in this embodiment.

### EMBODIMENT OF THE INVENTION

An embodiment of an instantaneous interruption monitoring system and an instantaneous interruption monitoring program according to the present invention will be described with reference to the drawings.

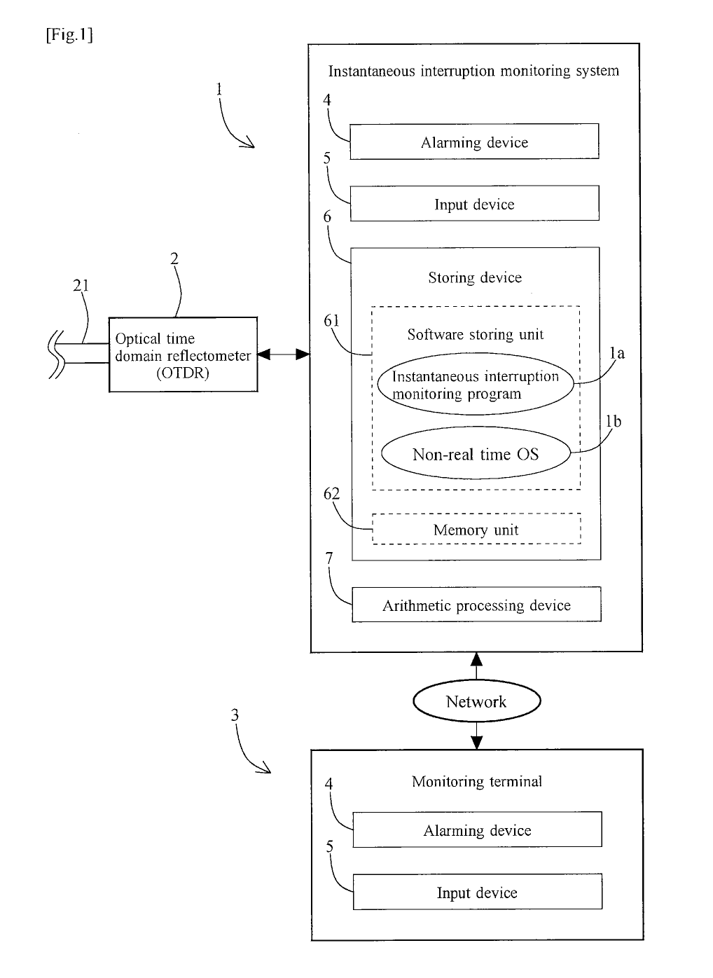

FIG. 1 is a block diagram showing overall configuration of an instantaneous interruption monitoring reporting network system including an instantaneous interruption monitoring system 1 of this embodiment. As shown in FIG. 1, the instantaneous interruption monitoring system 1 of this embodiment is connected to an optical time domain reflectometer (OTDR) 2 provided at an end of an optical cable 21 to be monitored and communicably configured with a monitoring terminal 3 via a prescribed network.

After the OTDR 2 emits an optical pulse to one end of an optical fiber, the OTDR 2 receives a backscattering light returned by Rayleigh scattering in the optical fiber to acquire temporal changes in position and intensity of the light as waveform data. In this embodiment, the OTDR 2 is configured so as to be operationally controlled by the instantaneous interruption monitoring system 1. In this embodiment, the OTDR 2 whose measurement time required is approximately 0.2 seconds is used, but it is not limited thereto.

The monitoring terminal 3 is a terminal for receiving a report from the instantaneous interruption monitoring system 1 and remotely controlling the instantaneous interruption monitoring system 1. In this embodiment, the monitoring terminal 3 is configured with a personal computer and a mobile phone, etc. and is communicably connected with the instantaneous interruption monitoring system 1 via a network such as Internet and local area network (LAN).

In this embodiment, the monitoring terminal 3 comprises an alarming device 4 which gives an operator a warning upon occurrence of an instantaneous interruption and an input device 5 which inputs a later-described measurement condition, reporting condition, etc. The alarming device 4 is configured with, for example, a display for showing a warning display picture, a speaker which gives an alarm, a warning lamp which is lit upon warning, etc. The input device 5 is configured with a mouse, a key board, etc.

In the above configuration, the instantaneous interruption monitoring system 1 of this embodiment accordingly acquires and records waveform data from the OTDR 2 at a prescribed time interval, and based on the waveform data, detects the occurrence of an instantaneous interruption and reports detected results thereof to the monitoring terminal 3.

The instantaneous interruption monitoring system 1 of this embodiment will be described in detail. As shown in FIG. 1, the instantaneous interruption monitoring system 1 of this embodiment mainly comprises an alarming device 4 which gives a warning upon the occurrence of an instantaneous interruption, an input device 5 which inputs a later-described measurement condition, etc., a storing device 6 which stores an instantaneous interruption monitoring program 1a of this embodiment and various data, etc., and an arithmetic processing device 7 which controls each of the constituent devices, acquires various data and executes arithmetic processing.

Herein, each of the constituent devices will be described in detail. The alarming device 4 gives an operator an alarm upon the occurrence of an instantaneous interruption. In this embodiment, the alarming device 4, like an alarming device 4 in a monitoring terminal 3, is configured with a display which shows a warning display picture, a speaker which gives an alarm, a warning lamp which is lit upon warning, etc. The input device 5 is configured with a mouse, a key board, etc.

The storing device 6 is configured with a hard disk, a flash memory, a random access memory (RAM), etc., and mainly comprises a software storing unit 61 and a memory unit 62 as shown in FIG. 1.

The instantaneous interruption monitoring program 1a of this embodiment and a non-real time OS 1b (hereinafter called non-real time OS) as a basic software of the instantaneous interruption monitoring system 1 are installed in the software storing unit 61. The arithmetic processing device 7 executes the instantaneous interruption monitoring program 1a on the non-real time OS 1b to allow a computer to function as the instantaneous interruption monitoring system 1 of this embodiment.

In this embodiment, the non-real time OS 1b represents a concept, covering all types of operating system corresponding to office automation, such as Windows (registered trademark). Specifically, the non-real time OS 1b is composed of any OS, other than real time OS, which is dedicated to executing processing in real time, having functions required therefor are mounted.

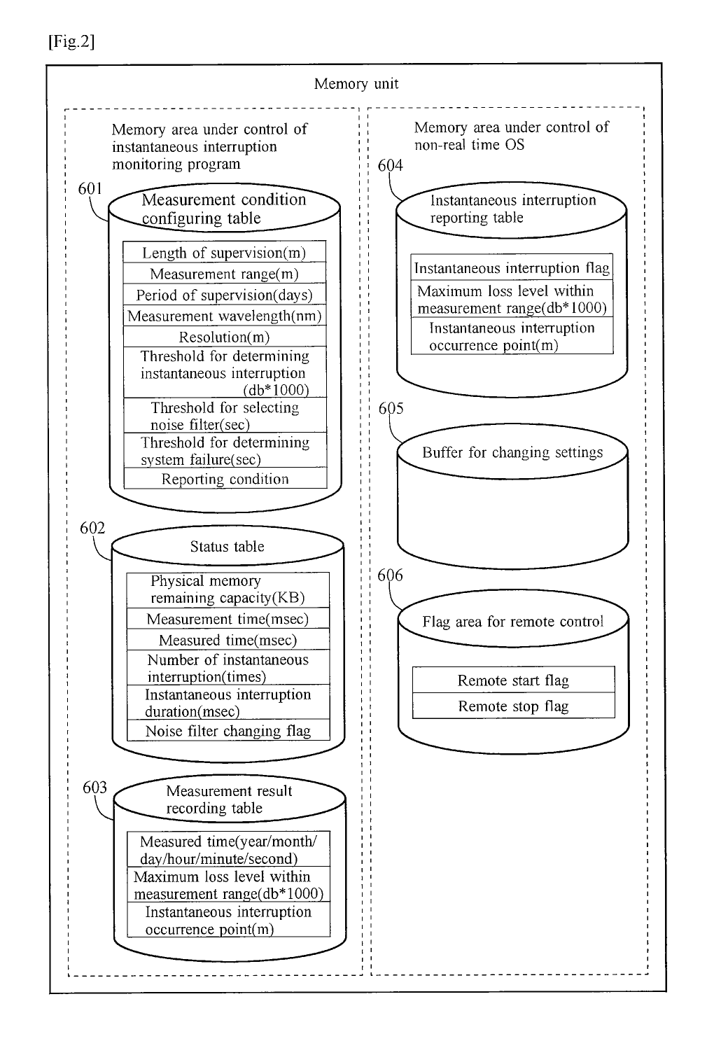

Meanwhile, the memory unit 62, as shown in FIG. 2, mainly comprises a memory area controlled by the instantaneous interruption monitoring program 1a and a memory area controlled by the non-real time OS 1b. The following various tables and buffer areas are mapped to each of the memory areas by a later-described memory mapping unit 701.

Each memory area of the memory unit 62 will be described in more detail. A memory area under control of the instantaneous interruption monitoring program 1a comprises a measurement condition configuring table 601, a status table 602 and a measurement result recording table 603 assigned therein. Meanwhile, a memory area controlled by the non-real time OS 1b comprises an instantaneous interruption reporting table 604, a buffer for changing settings 605 and a flag area for remote control 606 assigned therein.

The measurement condition configuring table 601 is to configure a measurement condition in the instantaneous interruption monitoring system 1 of this embodiment, and to store a length of supervision, a measurement range, a period of supervision, a measurement wavelength, a resolution, a threshold for determining instantaneous interruption, a threshold for selecting noise filter, a threshold for determining system failure and a reporting condition as shown in FIG. 2.

The length of supervision is a total length of the optical cable 21 to be measured. The measurement range is an actual measurement range in the optical cable 21 to be measured, and is defined as a distance from an end on the OTDR 2 side. In this embodiment, the measurement range is selected from three distances of 10 km, 20 km and 50 km, but is not limited thereto. The period of supervision is a period of time monitored by the instantaneous interruption monitoring system 1.

The measurement wavelength is a length of an optical pulse used in measurement by the OTDR 2, and in this embodiment, is selected from four wavelengths of 1310 nm, 1550 nm, 1625 nm and 1650 nm, but is not limited thereto. The resolution is a minimum-unit interval when the OTDR 2 acquires waveform data, which is set according to the OTDR 2. In this embodiment, when the measurement range is 10 km, the resolution is 50 cm, and when the measurement range is 20 km or 50 km, the resolution is 1 m.

The threshold for determining instantaneous interruption is a reference threshold for determining whether an instantaneous interruption occurs or not, and in this embodiment, is set within the range from 2 dB to 10 dB. As later described, based on whether a loss level of light in the optical cable 21 exceeds the threshold for determining instantaneous interruption or not, whether an instantaneous interruption occurs or not is determined.

The threshold for selecting noise filter is a reference threshold for selecting an optimum noise filter from plural types of noise filters, and in this embodiment, is set within the range from 0.2 to 1.0 seconds. Herein, the noise filter is a digital filter for removing a short-cycle noise component from waveform data acquired from the OTDR 2.

In this embodiment, a noise filter can be selected from the following four types in advance whose processing time configured is the longest in case (1), followed by cases (2) to (4).

(1) A combination of all waveform data and high-order finite impulse response (FIR) filter
(2) A combination of all waveform data and low-order FIR filter
(3) A combination of partially-sampled waveform data and low-order FIR filter
(4) No use of filter

While a generally “efficient-filtration” high-order noise filter effectively cuts off noise but a processing time thereof is long, an “inefficient filtration” low-order noise filter cannot completely cut off noise, with a short processing time. Therefore, the operator can configure an optimum threshold for selecting noise filter in view of previous instantaneous interruption accidents according to a purpose of use. Hereby, as later described, an optimum noise filter is selected within the range below the threshold for selecting noise filter.

The threshold for determining system failure is a reference threshold for determining whether failure occurs in the instantaneous interruption monitoring system 1 or not, and is not particularly limited thereto, but in this embodiment, is set within the range from 0.2 to 1.0 second. In this embodiment, the threshold for determining system failure is determined at over a threshold for selecting noise filter. As later described, based on whether a measured time by the OTDR 2 exceeds threshold for determining system failure or not, the occurrence of system failure is determined.

The reporting conditions are various conditions for reporting the occurrence of an instantaneous interruption or system failure. In this embodiment, a reporting condition to be configured is a unit to be reported, i.e. either a terminal of the instantaneous interruption monitoring system 1 or the monitoring terminal 3, and a reporting method for reporting the occurrence of an instantaneous interruption or system failure to the unit.

Next, the status table 602 will be described. The status table 602 records various statuses regarding the instantaneous interruption monitoring system 1, and a status regarding an instantaneous interruption detected, and stores a remaining capacity of a physical memory, a measurement time, a measured time, an instantaneous interruption number, an instantaneous interruption duration and a noise filter changing flag as shown in FIG. 2.

The physical memory remaining capacity and the measurement time are used in a later-described self-diagnosis processing. In this embodiment, the physical memory remaining capacity is an empty area of a physical memory incorporated in the instantaneous interruption monitoring system 1. The measurement time is obtained by adding waveform data acquiring time required for acquiring waveform data for self-diagnosis by the OTDR 2 and a noise removing processing time required for removing noise by each noise filter. In this embodiment, the measurement time is stored for each of the above four types of noise filters.

The measured time is compared with the above threshold for determining system failure and obtained by adding waveform data acquiring time required for acquiring measured waveform data actually measured by the OTDR 2 and a noise removing processing time required for removing noise by noise filter selected.

The instantaneous interruption number and the instantaneous interruption duration are used in a later-described noise filter changing processing. The instantaneous interruption number is a number of times of instantaneous interruptions which occur after supervision starts, i.e. a number of times counted when a loss level exceeds the threshold for determining instantaneous interruption. In this embodiment, the instantaneous interruption number increases by 1 when a loss level which is under the threshold for determining instantaneous interruption exceeds said threshold, and even when the status exceeding said threshold continues, the number doesn't increase. The instantaneous interruption duration is defined as a time of continued instantaneous interruption which occurs, i.e. a time during which a loss level continues to exceed the threshold for determining instantaneous interruption.

The noise filter changing flag is a flag for configuring by ON/OFF whether a later-described noise filter changing processing changes a noise filter or not. In this embodiment, the noise filter changing flag is configured at ON when a noise filter is changed. Meanwhile, upon the start of supervision measurement, the noise filter changing flag is configured at OFF.

Next, the measurement result recording table 603 will be described. The measurement result recording table 603 records a measurement result by the instantaneous interruption monitoring system 1 of this embodiment. In this embodiment, each time the instantaneous interruption monitoring system 1 determines a loss level by acquiring waveform data from the OTDR 2, a measured time, a maximum loss level within a measurement range and an instantaneous interruption occurrence point are stored as log data as shown in FIG. 2.

The measured time shows a time at which the OTDR 2 measures waveform data, and it is stored in the form of “year/month/day/hour/minute/second” in this embodiment. The maximum loss level within the measurement range is a maximum value of loss level in a measurement range configured in the measurement condition configuring table 601. The instantaneous interruption occurrence point is a point at which an instantaneous interruption occurs, and is defined as a distance from an end on the OTDR 2 side to a point at which a loss level first exceeds the threshold for determining instantaneous interruption. In this embodiment, when a loss level doesn't exceed the threshold for determining instantaneous interruption, a distance to a far end of the optical cable 21 is stored as the instantaneous interruption occurrence point.

Meanwhile, the instantaneous interruption reporting table 604 prepared in a memory area under control of the non-real time OS 1b, upon the occurrence of an instantaneous interruption, records instantaneous interruption information regarding its instantaneous interruption, and stores an instantaneous interruption flag and a maximum loss level within a measurement range and an instantaneous interruption occurrence point as shown in FIG. 2.

The instantaneous interruption flag configures whether an instantaneous interruption is found or not by ON/OFF. In this embodiment, when the occurrence of an instantaneous interruption is determined, or that a loss level exceeds the threshold for determining instantaneous interruption is determined, the instantaneous interruption flag is configured at ON. Meanwhile, the instantaneous interruption flag which is configured at ON is configured at OFF when an instantaneous interruption is reported to monitoring terminal 3.

The maximum loss level within a measurement range and the instantaneous interruption occurrence point are identical to the data stored in the measurement result recording table 603.

Next, the buffer for changing settings 605 is an area for temporarily storing a command, i.e. a change in measurement condition from the monitoring terminal 3. The flag area for remote control 606 is an area for configuring start command or stop command of the instantaneous interruption monitoring system 1 from the monitoring terminal 3 by ON/OFF, having a remote start flag and a remote stop flag. These flags are configured at ON when a command is given from the monitoring terminal 3, and when the instantaneous interruption monitoring system 1 is started or stopped according to said flag, they are configured at OFF.

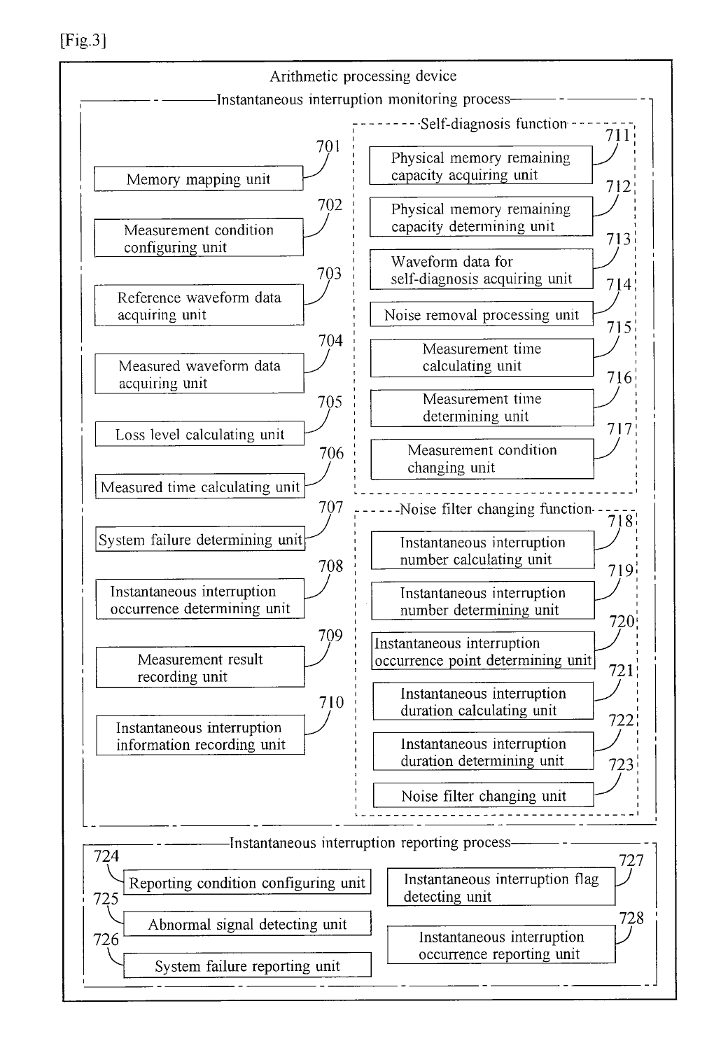

The arithmetic processing device 7 is configured with central processing unit (CPU), etc., and by executing the instantaneous interruption monitoring program 1a on the non-real time OS 1b stored in the software storing unit 61 of the storing device 6, an instantaneous interruption monitoring process and an instantaneous interruption reporting process are concurrently executed as shown in FIG. 3.

Each component to execute each process will be described in more detail. First, the instantaneous interruption monitoring process, as shown in FIG. 3, mainly comprises a memory mapping unit 701, a measurement condition configuring unit 702, a reference waveform data acquiring unit 703, a measured waveform data acquiring unit 704, a loss level calculating unit 705, a measured time calculating unit 706, a system failure determining unit 707, an instantaneous interruption occurrence determining unit 708, a measurement result recording unit 709 and an instantaneous interruption information recording unit 710. Also, the instantaneous interruption monitoring process is provided with, as later described, optional functions of a self-diagnosis function and a noise filter changing function.

The memory mapping unit 701 maps various types of tables and buffers to a memory area in the memory unit 62. In this embodiment, the memory mapping unit 701 maps the above described measurement condition configuring table 601, the status table 602 and the measurement result recording table 603 to a memory area controlled by the instantaneous interruption monitoring program 1a. The memory mapping unit 701 maps the above described instantaneous interruption reporting table 604, the buffer for changing settings 605 and the flag area for remote control 606 to a memory area controlled by the non-real time OS 1b.

The measurement condition configuring unit 702 configures a measurement condition inputted by the operator to the measurement condition configuring table 601. Specifically, the measurement condition configuring unit 702 acquires a measurement condition inputted from the input device 5 of the instantaneous interruption monitoring system 1 and configures the measurement condition to the measurement condition configuring table 601. Meanwhile, a measurement condition transmitted from the input device 5 of the monitoring terminal 3 by remote control is temporarily stored in the buffer for changing settings 605, thereby allowing the measurement condition configuring unit 702 to acquire a measurement condition from this buffer for changing settings 605 and to configure the measurement condition in the measurement condition configuring table 601.

The reference waveform data acquiring unit 703 acquires reference waveform data at a status where no instantaneous interruption occurs from the OTDR 2. The reference waveform data are reference waveform data which act as a benchmark for determining whether an instantaneous interruption occurs or not. In this embodiment, the reference waveform data acquiring unit 703 acquires a measurement condition configured in the measurement condition configuring table 601 and calls for measurement of reference waveform to the OTDR 2 under the measurement condition, thereby acquiring reference waveform data.

In this embodiment, as long as the data is waveform data acquired from an optical cable 21 normally used, it can be used as reference waveform data. However, waveform data acquired as reference waveform data might be waveform data upon the occurrence of an instantaneous interruption. Thus, the reference waveform data acquiring unit 703 preferably acquires reference waveform data two or more times and confirms that the data is waveform data at a status where no instantaneous interruption occurs.

The measured waveform data acquiring unit 704 accordingly acquires measured waveform data at a prescribed time interval from the OTDR 2. The measured waveform data is waveform data used as actual supervision measurement. In this embodiment, the measured waveform data acquiring unit 704 acquires a measurement condition configured in the measurement condition configuring table 601. Afterward, based on the measurement condition, the measured waveform data acquiring unit 704 outputs a supervision measurement command which calls for a supervision measurement to the OTDR 2 at a prescribed time interval. In this embodiment, the measured waveform data acquiring unit 704 is designed so as to output the supervision measurement command every approximately 200 millisecond according to a built-in clock of the instantaneous interruption monitoring system 1.

The loss level calculating unit 705 calculates a loss level of light in the optical cable 21. In this embodiment, the loss level calculating unit 705 calculates differential data between reference waveform data acquired by the reference waveform data acquiring unit 703 and measured waveform data acquired by the measured waveform data acquiring unit 704 and then refers to a noise filter changing flag configured in a status table 602.

When the noise filter changing flag is OFF, the loss level calculating unit 705 refers to a threshold for selecting noise filter configured in the measurement condition configuring table 601 and a measurement time of each noise filter stored in the status table 602. Afterward, the loss level calculating unit 705 calculates a loss level by removing a noise component of the differential data using a noise filter having a maximum measurement time within a threshold for selecting noise filter.

Meanwhile, when the noise filter changing flag is ON, the noise filter is changed to a higher-order noise filter by a later-described noise filter changing processing. Thus, the loss level calculating unit 705 removes a noise component of the differential data by using the replaced noise filter.

The measured time calculating unit 706 calculates a measured time each time supervision measurement is performed in order to detect failure which occurs in the OTDR 2 and a communication port after a supervision measurement starts. In this embodiment, the measured time calculating unit 706 acquires waveform data acquiring time for acquiring measured waveform data after the measured waveform data acquiring unit 704 outputs the supervision measurement command to the OTDR 2 and a noise removing processing time required for calculating differential data and for removing noise by the loss level calculating unit 705. Afterward, the measured time calculating unit 706 calculates a measured time by adding the waveform data acquiring time and the noise removing processing time, and stores it in the status table 602.

The system failure determining unit 707 determines whether any failure occurs in the instantaneous interruption monitoring system 1 or not. In this embodiment, the system failure determining unit 707 compares a threshold for determining system failure configured in the measurement condition configuring table 601 and a measured time stored in the status table 602. When the measured time exceeds the threshold for determining system failure, the system failure determining unit 707 determines that any failure can occur in the instantaneous interruption monitoring system 1, thereby outputting an abnormal signal to the instantaneous interruption reporting process.

The instantaneous interruption occurrence determining unit 708 determines whether an instantaneous interruption occurs or not. In this embodiment, the instantaneous interruption occurrence determining unit 708 compares a loss level calculated by the loss level calculating unit 705 and a threshold for determining instantaneous interruption configured in the measurement condition configuring table 601. When the loss level exceeds the threshold for determining instantaneous interruption, the occurrence of an instantaneous interruption is determined.

The measurement result recording unit 709 records various types of measurement results regarding the loss level on the measurement result recording table 603. In this embodiment, the measurement result recording unit 709 accordingly stores a measured time in the OTDR 2, a maximum loss level within a measurement range and an instantaneous interruption occurrence point in the measurement result recording table 603, each time the instantaneous interruption occurrence determining unit 708 determines whether an instantaneous interruption occurs or not.

The maximum loss level within the measurement range to be stored is defined as a loss level maximum value calculated by the loss level calculating unit 705 within the measurement range. When the instantaneous interruption occurrence determining unit 708 determines that no instantaneous interruption occurs, a distance from a near end to a far end of the optical cable 21 is stored as the instantaneous interruption occurrence point.

The instantaneous interruption information recording unit 710 records various types of instantaneous interruption information regarding instantaneous interruption. In this embodiment, when the instantaneous interruption occurrence determining unit 708 determines that an instantaneous interruption occurs, the instantaneous interruption information recording unit 710 records instantaneous interruption information regarding said instantaneous interruption on the instantaneous interruption reporting table 604. Specifically, the instantaneous interruption information recording unit 710 configures an instantaneous interruption flag of the instantaneous interruption reporting table 604 at ON. A maximum loss level within a measurement range and an instantaneous interruption occurrence point are stored in the instantaneous interruption reporting table 604.

Next, each component of self-diagnosis function will be described. The self-diagnosis function is a function for self-diagnosis of the performance of the instantaneous interruption monitoring system 1 before supervision of an instantaneous interruption starts, comprising a remaining capacity of a physical memory acquiring unit 711, a physical memory remaining capacity determining unit 712, a waveform data for self-diagnosis acquiring unit 713, a noise removal processing unit 714, a measurement time calculating unit 715, a measurement time determining unit 716 and a measurement condition changing unit 717.

The physical memory remaining capacity acquiring unit 711 acquires a remaining capacity of a physical memory incorporated in the instantaneous interruption monitoring system 1. In this embodiment, the physical memory remaining capacity acquiring unit 711 is configured with application program interface (API) provided by an OS manufacturer. For example, when an OS is Windows (registered trademark), software known as Windows API is pre-installed therein, and an empty area of a physical memory is acquired using the same.

The physical memory remaining capacity determining unit 712 determines whether a remaining capacity of a physical memory of the instantaneous interruption monitoring system 1 corresponds to a memory volume required in the instantaneous interruption monitoring system 1 or not. In this embodiment, the physical memory remaining capacity determining unit 712 determines that up to half of a remaining capacity of a physical memory acquired by the physical memory remaining capacity acquiring unit 711 is a memory volume which can be used in the instantaneous interruption monitoring system 1. This step is to prepare a sufficient empty area of a physical memory, because a memory volume used by an OS itself changes as time elapses. Also, in this embodiment, the memory volume required by the instantaneous interruption monitoring system 1 is designated by the instantaneous interruption monitoring program 1a in advance.

The waveform data for self-diagnosis acquiring unit 713 acquires waveform data for self-diagnosis of the performance of the instantaneous interruption monitoring system 1 from the OTDR 2. In this embodiment, the waveform data for self-diagnosis acquiring unit 713 acquires a measurement condition configured in the measurement condition configuring table 601 before supervision of an instantaneous interruption starts. Then, under the measurement condition, a command of acquiring waveform data for self-diagnosis is outputted to the OTDR 2. Waveform data for self-diagnosis acquired by the waveform data for self-diagnosis acquiring unit 713 is erased after being used for self-diagnosis processing.

The noise removal processing unit 714 removes a noise component of waveform data for self-diagnosis using each noise filter prepared in the instantaneous interruption monitoring system 1 in advance. In this embodiment, the noise removal processing unit 714 uses each of the above described 4 types of noise filters to remove a noise component of waveform data for self-diagnosis acquired by the waveform data for self-diagnosis acquiring unit 713.

The measurement time calculating unit 715 calculates a measurement time for each noise filter. Specifically, the measurement time calculating unit 715 acquires a waveform data acquiring time required for acquiring waveform data for self-diagnosis by the waveform data for self-diagnosis acquiring unit 713 and a noise removing processing time required for removing a noise component of waveform data for self-diagnosis by the noise removal processing unit 714 for each noise filter used. By adding the waveform data acquiring time and each noise removing processing time, a measurement time for each noise filter is calculated and stored in the status table 602.

The measurement time determining unit 716 determines whether a processing speed required in the instantaneous interruption monitoring system 1 is obtained or not, based on each measurement time. In this embodiment, the measurement time determining unit 716 acquires each measurement time calculated by the measurement time calculating unit 715 from the status table 602 to determine whether a shortest measurement time exceeds a threshold for selecting noise filter or not. Even using a filter of minimum order which is processible with a shortest time, when a measurement time thereof exceeds a threshold for selecting noise filter, an aim of monitoring instantaneous interruption cannot be achieved.

The measurement condition changing unit 717 changes a measurement condition according to a result of self-diagnosis. In this embodiment, when the physical memory remaining capacity determining unit 712 determines that the physical memory remaining capacity is insufficient, the measurement condition changing unit 717 calculates a period of supervision which can be monitored by the remaining capacity of a physical memory. By changing a period of supervision configured in the measurement condition configuring table 601 to said period of supervision, a remaining capacity of a physical memory is increased.

When the measurement time determining unit 716 determines that a shortest measurement time exceeds a threshold for selecting noise filter, the measurement condition changing unit 717 changes the threshold for selecting noise filter stored in the measurement condition configuring table 601 to a larger value. However, the threshold for selecting noise filter is limited to a value ranging from 0.2 to 1.0 second to monitor instantaneous interruption as described above. Therefore, when a shortest measurement time exceeds 1.0 second, a computer thereof cannot be used.

In this embodiment, the measurement condition changing unit 717 changes a period of supervision and a threshold for selecting noise filter, but it is not limited thereto, and other measurement conditions can be changed. In this embodiment, the measurement condition changing unit 717 automatically changes a measurement condition, but is not limited to this configuration and the operator may change the condition manually.

Specifically, when a remaining capacity of a physical memory is insufficient, a message saying “insufficient physical memory remaining capacity” is displayed, and a measurement condition which can be monitored is displayed by the menu form to allow the operator to review reduction in period of supervision, etc. When said shortest measurement time exceeds a threshold for selecting noise filter, a message saying “too much measurement time” is displayed and a screen for changing a measurement condition is displayed by the menu form to allow the operator to review a change in a threshold for selecting noise filter.

Next, each component of a noise filter changing function will be described. The noise filter changing function is a function of changing a noise filter to identify an instantaneous interruption occurrence point in more detail when an instantaneous interruption occurs, comprising an instantaneous interruption number calculating unit 718, an instantaneous interruption number determining unit 719, an instantaneous interruption occurrence point determining unit 720, an instantaneous interruption duration calculating unit 721, an instantaneous interruption duration determining unit 722 and a noise filter changing unit 723.

The instantaneous interruption number calculating unit 718 calculates an instantaneous interruption number of instantaneous interruptions which already occur in total. In this embodiment, the instantaneous interruption number calculating unit 718 acquires an instantaneous interruption number recorded on the status table 602 when the instantaneous interruption occurrence determining unit 708 determines that an instantaneous interruption occurs. By adding one to the instantaneous interruption number, an instantaneous interruption number after supervision starts is calculated.

The instantaneous interruption number determining unit 719 determines an instantaneous interruption number after supervision starts. In this embodiment, the instantaneous interruption number determining unit 719 acquires an instantaneous interruption number calculated by the instantaneous interruption number calculating unit 718 from the status table 602 to determine whether the instantaneous interruption number is two or more, or not.

The instantaneous interruption occurrence point determining unit 720 determines the identity of a point at which an instantaneous interruption occurs. In this embodiment, when the instantaneous interruption number determining unit 719 determines that an instantaneous interruption number is two or more, or not, the instantaneous interruption occurrence point determining unit 720 acquires a latest instantaneous interruption occurrence point and a previous instantaneous interruption occurrence point from the measurement result recording table 603 to determine whether these points are identical or not. This identity determination requires no perfect identity, but an error of e.g. ±1 m may be allowed.

The instantaneous interruption duration calculating unit 721 calculates a time (duration) of instantaneous interruption. In this embodiment, the instantaneous interruption duration calculating unit 721 acquires an instantaneous interruption duration recorded on the status table 602 when the instantaneous interruption occurrence point determining unit 720 determines that a latest instantaneous interruption occurrence point and a previous instantaneous interruption occurrence point are identical. Also, the instantaneous interruption duration calculating unit 721 acquires a latest measured time and a previous measured time from the measurement result recording table 603 to calculate a differential time therebetween. By adding the differential time to the instantaneous interruption duration acquired, an instantaneous interruption duration is updated.

The instantaneous interruption duration determining unit 722 determines a length of an instantaneous interruption duration. In this embodiment, the instantaneous interruption duration determining unit 722 acquires an instantaneous interruption duration calculated by the instantaneous interruption duration calculating unit 721 from the status table 602 to determine whether the instantaneous interruption duration exceeds a threshold for selecting noise filter configured in the measurement condition configuring table 601 or not.

The noise filter changing unit 723 changes a noise filter to acquire an instantaneous interruption occurrence point in more detail. In this embodiment, the noise filter changing unit 723 acquires a threshold for determining system failure from the measurement condition configuring table 601 and acquires a measurement time of each noise filter from the status table 602 when the instantaneous interruption duration determining unit 722 determines that an instantaneous interruption duration exceeds a threshold for selecting noise filter. Then, in noise filters whose measurement time is smaller than the threshold for determining system failure, the currently used noise filter is changed to a higher-order noise filter. When a highest-order noise filter is used, a noise filter is not changed.

Meanwhile, the instantaneous interruption reporting process is automatically and concurrently executed with the above described instantaneous interruption monitoring process, mainly comprising a reporting condition configuring unit 724, an abnormal signal detecting unit 725, a system failure reporting unit 726, an instantaneous interruption flag detecting unit 727 and an instantaneous interruption occurrence reporting unit 728 as shown in FIG. 3.

The reporting condition configuring unit 724 configures a reporting condition upon the occurrence of an instantaneous interruption and upon the occurrence of system failure. Specifically, the reporting condition configuring unit 724 acquires a reporting condition inputted from the input device 5 of the instantaneous interruption monitoring system 1 or the monitoring terminal 3 to configure this reporting condition to the measurement condition configuring table 601. In this embodiment, as a reporting condition, a location to be reported and a reporting method for reporting to this location can be configured.

The location to be reported may be designated as either the instantaneous interruption monitoring system 1 or the monitoring terminal 3, or both. The reporting method can be designated as a method for displaying a warning display picture on the screen, a method for giving an alarm from the speaker and a method for lighting a warning lamp according to the alarming device 4 provided in the instantaneous interruption monitoring system 1 or the monitoring terminal 3.

The abnormal signal detecting unit 725 detects an abnormal signal outputted from the system failure determining unit 707 of the instantaneous interruption monitoring process. In this embodiment, the abnormal signal detecting unit 725 constantly checks whether the system failure determining unit 707 has outputted an abnormal signal or not. Afterward, when an abnormal signal is detected, the signal is reported to the system failure reporting unit 726.

The system failure reporting unit 726 reports the occurrence of failure to the instantaneous interruption monitoring system 1. In this embodiment, the system failure reporting unit 726 reports the occurrence of any failure in the instantaneous interruption monitoring system 1 to the instantaneous interruption monitoring system 1 or the monitoring terminal 3 according to a reporting condition configured in the measurement condition configuring table 601 when the abnormal signal detecting unit 725 detects an abnormal signal.

The instantaneous interruption flag detecting unit 727 detects an instantaneous interruption flag configured in the instantaneous interruption reporting table 604. In this embodiment, the instantaneous interruption flag detecting unit 727 has access to the instantaneous interruption reporting table 604 once tens of milliseconds to determine whether the instantaneous interruption flag is configured at ON or not. Then, when the instantaneous interruption flag is configured at ON, it is reported to the instantaneous interruption occurrence reporting unit 728 and the instantaneous interruption flag is configured at OFF.

The instantaneous interruption occurrence reporting unit 728 reports the occurrence of an instantaneous interruption. In this embodiment, the instantaneous interruption occurrence reporting unit 728 reports the occurrence of an instantaneous interruption to the instantaneous interruption monitoring system 1 or the monitoring terminal 3 according to a reporting condition configured in the measurement condition configuring table 601 when the instantaneous interruption flag detecting unit 727 detects ON status of the instantaneous interruption flag.

Next, operations of the instantaneous interruption monitoring system 1 executed by the instantaneous interruption monitoring program 1a of this embodiment will be described with reference to the drawings.

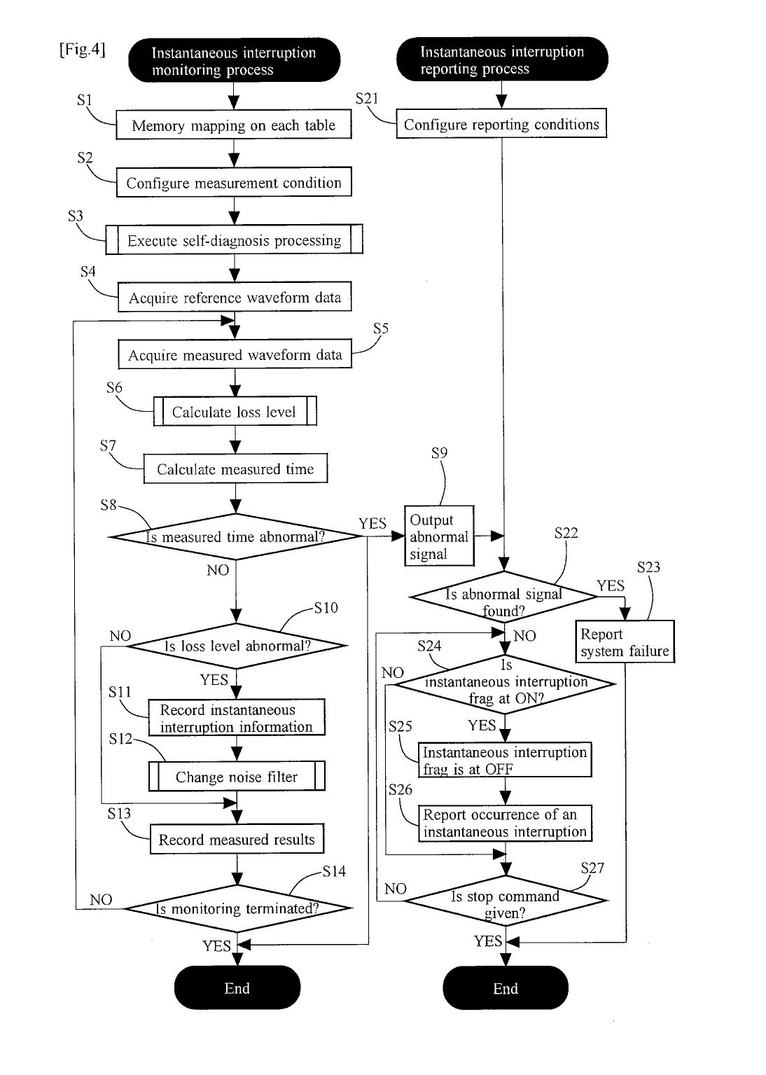

When instantaneous interruption which occurs in the optical cable 21 is monitored using the instantaneous interruption monitoring system 1 of this embodiment, the operator starts the instantaneous interruption monitoring program 1a of this embodiment. Afterward, the instantaneous interruption monitoring process and the instantaneous interruption reporting process are simultaneously executed with the instantaneous interruption monitoring system 1 as shown in FIG. 4.

In an instantaneous interruption monitoring process as shown in FIG. 4, the memory mapping unit 701 firstly maps the measurement condition configuring table 601, the status table 602 and the measurement result recording table 603 to a memory area controlled by the instantaneous interruption monitoring program 1a. Also, the memory mapping unit 701 maps the instantaneous interruption reporting table 604, the buffer for changing settings 605 and the flag area for remote control 606 to a memory area controlled by the non-real time OS 1b (step S1).

Consequently, while a memory area under control of the instantaneous interruption monitoring program 1a performs an operation such as continuously storing an enormous amount of measurement results obtained from the OTDR 2, a memory area under control of the non-real time OS 1b performs an operation such as reporting the occurrence of an instantaneous interruption, etc. by serving as interface with the instantaneous interruption reporting process. Therefore, even in a computer incorporating the non-real time OS 1b, a real-time reporting can be done concurrently with the operation which records measurement results accordingly.

After mapping to a memory area is completed, the measurement condition configuring unit 702 acquires various types of measurement conditions inputted from the instantaneous interruption monitoring system 1 or the monitoring terminal 3, and configures the measurement condition to the measurement condition configuring table 601 (step S2). Then, a measurement condition transmitted from the monitoring terminal 3 by remote control is temporarily stored in the buffer for changing settings 605, thereby using no memory area under control of the instantaneous interruption monitoring program 1a.

The operator preferably configures a threshold for selecting noise filter at an appropriate value in view of properties of instantaneous interruption to be focused and previous instantaneous interruption accidents. Specifically, in cases where completely instantaneous interruption is focused, a low-order noise filter can be used due to a large loss level. Accordingly, in this case, a threshold for selecting noise filter is configured at a small value and a processing time is given priority rather than the identification of an instantaneous interruption occurrence point.

Meanwhile, when an instantaneous interruption of a loss level having several decibels (dB) is focused, it is necessary to use a high-order noise filter due to a small loss level. Accordingly, in this case, a threshold for selecting noise filter is configured at a large value and detail identification of an instantaneous interruption occurrence point is given priority rather than a processing time.

An optical cable line significantly varies in a loss level within a measurement range even in a normal optical cable 21 due to a difference in the number of connecting points in-between, type of connection (by fusion splicing or connector) and wavelength in use. Thus, unless a high-performance noise filter is used, waveform data might not be compared and accordingly a threshold for selecting noise filter and a threshold for determining system failure must be configured at larger values. Meanwhile, in cases where the number of connecting points is 1 or 2, and the optical cable 21 is based on fusion splicing, a high-performance filter is not required. Consequently, a threshold for selecting noise filter and a threshold for determining system failure may be configured at smaller values.

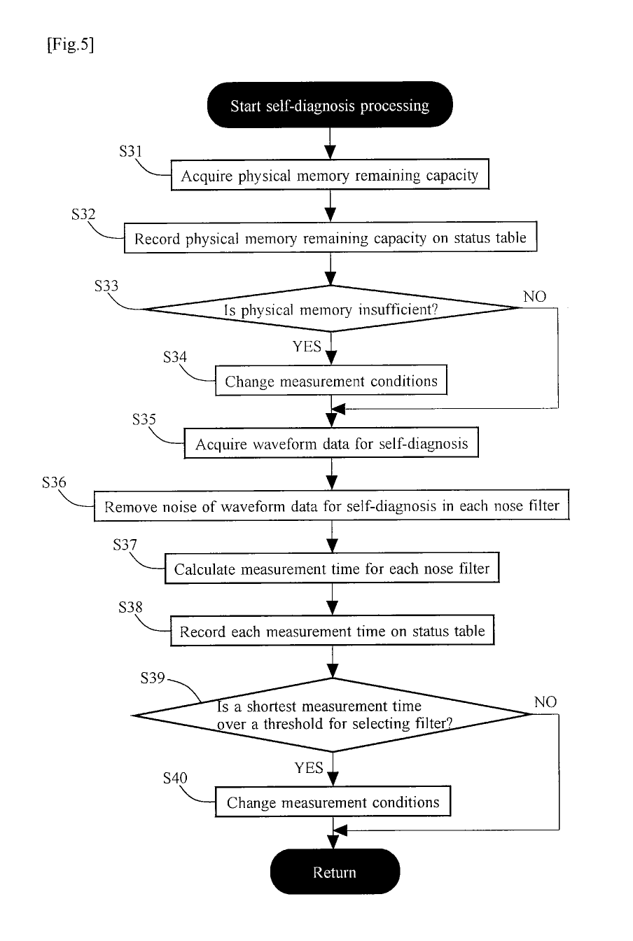

After a measurement condition is completely configured, self-diagnosis processing is performed before supervision measurement starts (step S3) in this embodiment. Self-diagnosis processing of this embodiment will be described with reference to FIG. 5.

First, the physical memory remaining capacity acquiring unit 711 acquires a remaining capacity of a physical memory incorporated in the instantaneous interruption monitoring system 1 (step S31), and the physical memory remaining capacity is recorded on the status table 602 (step S32).

Subsequently, the physical memory remaining capacity determining unit 712 determines whether a remaining capacity of a physical memory recorded on the status table 602 by this step S32 corresponds to a memory volume required in the instantaneous interruption monitoring system 1 or not (step S33). As a result, when it is determined that the physical memory remaining capacity is sufficient, (step S33: NO), the process proceeds to step S35.

Meanwhile, when it is determined that the physical memory remaining capacity is insufficient (step S33: YES), the measurement condition changing unit 717 changes a measurement condition configured in the measurement condition configuring table 601 (step S34). In this embodiment, the measurement condition changing unit 717 reduces a period of supervision, thereby allocating a physical memory required for executing the instantaneous interruption monitoring program 1a.

Next, the waveform data for self-diagnosis acquiring unit 713 acquires waveform data for self-diagnosis from the OTDR 2 based on a measurement condition configured in the measurement condition configuring table 601 (step S35), and the noise removal processing unit 714 removes a noise component of waveform data for self-diagnosis using 4 types of noise filters (step S36).

Then, the measurement time calculating unit 715 calculates a measurement time for each noise filter by adding a waveform data acquiring time required for acquiring waveform data for self-diagnosis in step S35 and a noise removing processing time required for removing a noise component by each noise filter in step S36 (step S37) and stores each of these measurement times in the status table 602 (step S38).

Subsequently, the measurement time determining unit 716 determines whether a shortest measurement time in the data stored in the status table 602 in step S38 exceeds a threshold for selecting noise filter configured in the measurement condition configuring table 601 or not (step S39). As a result, if the shortest measurement time doesn't exceed a threshold for selecting noise filter (step S39: NO), self-diagnosis processing will be completed.

Meanwhile, in cases where said shortest measurement time exceeds a threshold for selecting noise filter (step S39: YES), the measurement condition changing unit 717 changes a measurement condition configured by the measurement condition configuring table 601 (step S40). In this embodiment, the measurement condition changing unit 717 changes a threshold for selecting noise filter to a larger value. Accordingly, even a computer whose processing speed is slightly low can be used as the instantaneous interruption monitoring system 1, as long as the processing speed is within a range which guarantees a supervision measurement of an instantaneous interruption.

After the above self-diagnosis processing is completed, the operation will return to a flowchart diagram as shown in FIG. 4, and based on a measurement condition configured in the measurement condition configuring table 601, the reference waveform data acquiring unit 703 acquires reference waveform data from the OTDR 2 (step S4). Consequently, reference waveform data for determining whether an instantaneous interruption occurs or not are obtained.

After acquiring reference waveform data, the instantaneous interruption monitoring process starts a repetitive loop processing from the following steps S5 to S14. First, the measured waveform data acquiring unit 704 accordingly acquires measured waveform data from the OTDR 2 at an extremely short time interval, based on a measurement condition configured in the measurement condition configuring table 601 (step S5).

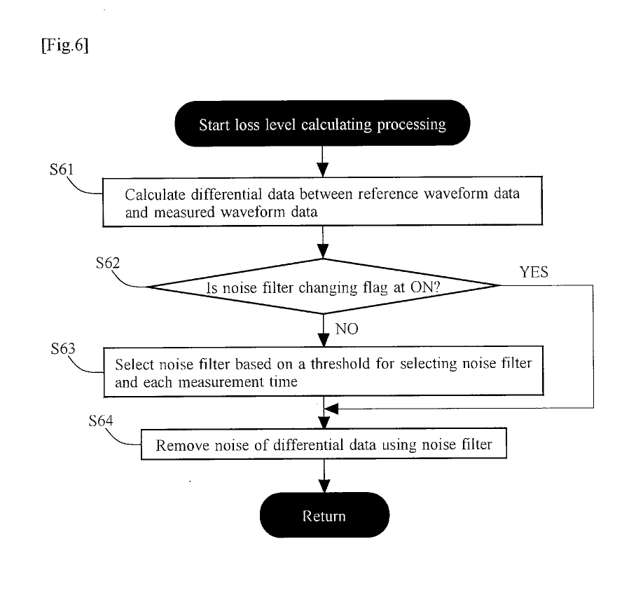

Then, the loss level calculating unit 705 calculates a loss level of the optical cable 21, based on reference waveform data acquired in step S4 and measured waveform data acquired in step S5 (step S6). Specifically, the loss level calculating unit 705 first calculates differential data between reference waveform data and measured waveform data as shown in FIG. 6 (step S61).

Subsequently, the loss level calculating unit 705 refers to a noise filter changing flag of the status table 602 (step S62). Then, in cases where the noise filter changing flag is configured at ON (step S62: YES), the processing proceeds to step S64. Meanwhile, in cases where the noise filter changing flag is configured at OFF (step S62: NO), the loss level calculating unit 705 selects a most appropriate noise filter, based on a threshold for selecting noise filter configured in the measurement condition configuring table 601 and a measurement time of each noise filter stored in the status table 602 (step S63).

In this embodiment, the loss level calculating unit 705 employs a noise filter having a maximum measurement time within a threshold for selecting noise filter. Consequently, a noise filter which can identify an instantaneous interruption occurrence point in most detail can be selected under a measurement condition configured according to properties of instantaneous interruption to be monitored.

Then, the loss level calculating unit 705 removes a noise component of differential data calculated in step S61, using a noise filter selected in step S63 or a noise filter changed in noise filter changing processing (step S64). Consequently, the noise component of differential data is removed, thereby acquiring a loss level which never detects instantaneous interruption mistakenly. In addition, in cases where a noise filter replaced is used, an instantaneous interruption occurrence point is identified in more detail.

When the loss level is calculated, the operation returns to a flowchart diagram as shown in FIG. 4, and the measured time calculating unit 706 calculates a measured time required for measuring said loss level (step S7). In this embodiment, the measured time calculating unit 706 acquires a waveform data acquiring time required for acquiring measured waveform data in step S5 and a noise removing processing time required for calculating the loss level in step S6. Then, a measured time obtained by adding the waveform data acquiring time and the noise removing processing time is calculated and stored in the status table 602.

After the measured time is calculated, the system failure determining unit 707 compares the measured time and a threshold for determining system failure to determine whether any failure occurs in the instantaneous interruption monitoring system 1 or not (step S8). As a result, in cases where the measured time is below a threshold for determining system failure (step S8: NO), it is determined that the instantaneous interruption monitoring system 1 is operated normally and the processing proceeds to step S10.

Meanwhile, in cases where a measured time exceeds a threshold for determining system failure (step S8: YES), it is determined that any failure occurs in the instantaneous interruption monitoring system 1 and an abnormal signal is outputted to the instantaneous interruption reporting process (step S9). Consequently, the occurrence of any failure in the OTDR 2 or the communication port during supervision measurement will be immediately detected.

If no failure is observed in the instantaneous interruption monitoring system 1, the instantaneous interruption occurrence determining unit 708 compares the loss level calculated in step S6 and a threshold for determining instantaneous interruption (step S10). As a result, in cases where the loss level is below a threshold for determining instantaneous interruption (step S10: NO), the processing proceeds to step S13.

Meanwhile, in cases where the loss level exceeds a threshold for determining instantaneous interruption (step S10: YES), it is determined that an instantaneous interruption occurs, and the instantaneous interruption information recording unit 710 records instantaneous interruption information regarding said instantaneous interruption on the instantaneous interruption reporting table 604 (step S11). In this embodiment, the instantaneous interruption information recording unit 710 configures an instantaneous interruption flag of the instantaneous interruption reporting table 604 at ON and stores a maximum loss level within a measurement range and an instantaneous interruption occurrence point in the instantaneous interruption reporting table 604.

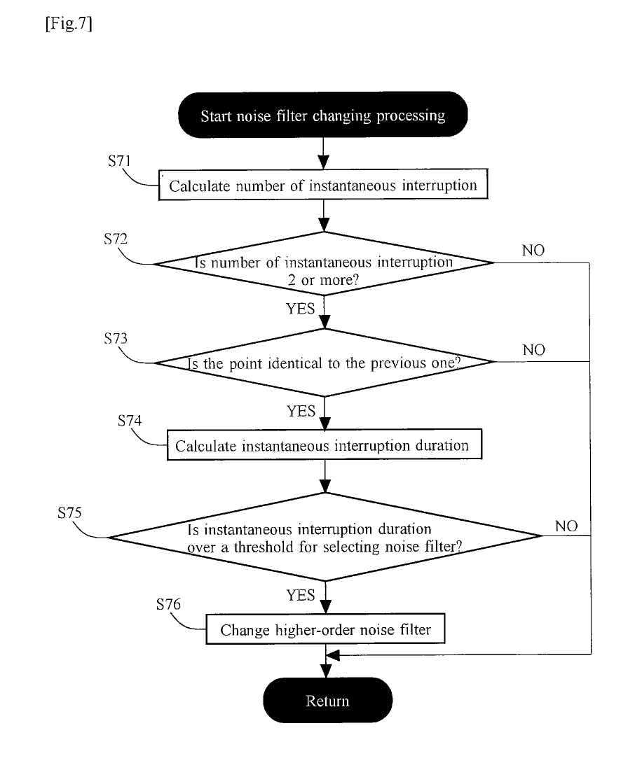

Subsequently, in this embodiment, a noise filter changing processing is executed (step S12) to identify an instantaneous interruption occurrence point in more detail. The noise filter changing processing of this embodiment will be described with reference to FIG. 7.

First, the instantaneous interruption number calculating unit 718 calculates a number of instantaneous interruptions which occur after supervision measurement starts in total (step S71), and the instantaneous interruption number determining unit 719 determines whether the instantaneous interruption number is two or more, or not (step S72). As a result, if the instantaneous interruption number is one or less (step S72: NO), the noise filter changing processing is completed.

Meanwhile, when it is determined that the instantaneous interruption number is two or more (step S72: YES), the instantaneous interruption occurrence point determining unit 720 determines whether the instantaneous interruption occurrence point and a previous instantaneous interruption occurrence point are identical or not (step S73). As a result, if the instantaneous interruption occurrence points are different (step S73: NO), the noise filter changing processing is completed.

On the other hand, when it is determined that the instantaneous interruption occurrence points are identical (step S73: YES), the instantaneous interruption duration calculating unit 721 calculates an instantaneous interruption duration of the instantaneous interruption which occurs (step S74). Then, the instantaneous interruption duration determining unit 722 determines whether the instantaneous interruption duration exceeds a threshold for selecting noise filter or not (step S75). As a result, when the instantaneous interruption duration is below a threshold for selecting noise filter (step S75: NO), the noise filter changing processing is completed.

In cases where the instantaneous interruption duration exceeds a threshold for selecting noise filter (step S75: YES), the noise filter changing unit 723 changes the noise filter used in this process to a higher-order noise filter whose measurement time is shorter than a threshold for determining system failure (step S76). Consequently, in cases where a loss level occurs at the identical points, it is assumed that an instantaneous interruption occurs due to the same cause, resulting in automatic selection of a noise filter which can identify an instantaneous interruption occurrence point in more detail.

After the above noise filter changing processing is completed, the operation returns to a flowchart diagram as shown in FIG. 4, and the measurement result recording unit 709 records various types of measurement results on the measurement result recording table 603 (step S13). Consequently, an enormous amount of measurement results obtained in each supervision measurement is assuredly and continuously recorded.

Then, at step S14, whether a stop command is inputted from the instantaneous interruption monitoring system 1 or the monitoring terminal 3 or not, or whether a period of supervision configured in the measurement condition configuring table 601 is terminated or not is determined (step S14). Afterward, in cases where a supervision measurement is continued (step S14: NO), the processing returns to step S5 and the above-described steps are repeated. Meanwhile, when the period of supervision is terminated (step S14: YES), the instantaneous interruption monitoring process is completed.

Next, processing executed in the instantaneous interruption reporting process will be described. In the instantaneous interruption reporting process as shown in FIG. 4, the reporting condition configuring unit 724 first configures a reporting condition upon the occurrence of an instantaneous interruption and upon the occurrence of system failure in the measurement condition configuring table 601 (step S21).

Also in the instantaneous interruption reporting process, the abnormal signal detecting unit 725 constantly checks whether an abnormal signal is outputted from the instantaneous interruption monitoring process or not (step S22). As a result, in cases where an abnormal signal is detected (step S22: YES), the system failure reporting unit 726 reports the occurrence of any failure in the instantaneous interruption monitoring system 1 to the instantaneous interruption monitoring system 1 or the monitoring terminal 3 (step S23), and the instantaneous interruption reporting process is completed. Consequently, even during a supervision measurement, the occurrence of failure in the OTDR 2 or the communication port is reported in real time.

Meanwhile, in cases where an abnormal signal is not detected (step S22: NO), the processing proceeds to step S24, and the instantaneous interruption flag detecting unit 727 determines the status of an instantaneous interruption flag configured in the instantaneous interruption reporting table 604 (step S24). As a result, in cases where the instantaneous interruption flag is OFF (step S24: NO), the processing proceeds to step S27.

On the other hand, in cases where the instantaneous interruption flag is ON (step S24: YES), the instantaneous interruption flag is configured at OFF (step S25) and thereafter the instantaneous interruption occurrence reporting unit 728 reports the occurrence of an instantaneous interruption to the instantaneous interruption monitoring system 1 or the monitoring terminal 3 (step S26). Consequently, in the instantaneous interruption reporting process, real-time reporting processing is assuredly and simultaneously executed with continuous recording process for measurement result in the instantaneous interruption monitoring processing.

At step S27 determines whether the operator of the instantaneous interruption monitoring system 1 or the monitoring terminal 3 gives a command of completion of supervision measurement or not is determined. As long as such a command is not given (step S27: NO), the processing returns to step S24 and the following processing are repeated. Meanwhile, when such a command is given (step S27: YES), the instantaneous interruption reporting process is completed.

This embodiment described above can provide the following advantages:

1. Even in a computer incorporating a non-real time OS 1b, an enormous amount of measurement results obtained from an OTDR 2 can be continuously stored, and the occurrence of an instantaneous interruption can be reported in real time.
2. Performance as the instantaneous interruption monitoring system 1 can be self-diagnosed, and a measurement condition can be appropriately changed.
3. By removing a noise component of a loss level, it is possible to prevent detection of the occurrence of an instantaneous interruption mistakenly.
4. It is possible to automatically change a noise filter to the one which can identify an instantaneous interruption occurrence point in more detail when an instantaneous interruption occurs.

An instantaneous interruption monitoring system 1 and an instantaneous interruption monitoring program 1a according to the present invention are not limited to the aforementioned embodiment, but may be altered accordingly.

For example, in this embodiment described above, a system composed of an instantaneous interruption monitoring system 1 and an OTDR 2 independently is described, but it is not limited thereto, and may be an integral system having the functions of both constituents.

### EXPLANATION OF LETTERS OR NUMERALS

1 Instantaneous interruption monitoring system
1a Instantaneous interruption monitoring program
1b Non-real time OS
2 Optical time domain reflectometer (OTDR)
3 Monitoring terminal
4 Alarming device
5 Input device
6 Storing device
7 Arithmetic processing device
21 Optical cable
61 Software storing unit
62 Memory unit
601 Measurement condition configuring table
602 Status table
603 Measurement result recording table
604 Instantaneous interruption reporting table
605 Buffer for changing settings
606 Flag area for remote control
701 Memory mapping unit
702 Measurement condition configuring unit
703 Reference waveform data acquiring unit
704 Measured waveform data acquiring unit
705 Loss level calculating unit
706 Measured time calculating unit
707 System failure determining unit
708 Instantaneous interruption occurrence determining unit
709 Measurement result recording unit
710 Instantaneous interruption information recording unit
711 Physical memory remaining capacity acquiring unit
712 Physical memory remaining capacity determining unit
713 Waveform data for self-diagnosis acquiring unit
714 Noise removal processing unit
715 Measurement time calculating unit
716 Measurement time determining unit
717 Measurement condition changing unit
718 Instantaneous interruption number calculating unit
719 Instantaneous interruption number determining unit
720 Instantaneous interruption occurrence point determining unit
721 Instantaneous interruption duration calculating unit
722 Instantaneous interruption duration determining unit
723 Noise filter changing unit
724 Reporting condition configuring unit
725 Abnormal signal detecting unit
726 System failure reporting unit
727 Instantaneous interruption flag detecting unit
728 Instantaneous interruption occurrence reporting unit

1. An instantaneous interruption monitoring system which monitors an instantaneous interruption that occurs in an optical cable using an optical time domain reflectometer connected to said optical cable, comprising
a software storing unit which stores an instantaneous interruption monitoring program which allows a computer to function as the instantaneous interruption monitoring system, and a non-real time operating system;
a memory unit in which a measurement condition configuring table and a measurement result recording table are mapped to a memory area controlled by said instantaneous interruption monitoring program and in which an instantaneous interruption reporting table is mapped to a memory area controlled by said non-real time operating system;
a reference waveform data acquiring unit which acquires reference waveform data at a status where no instantaneous interruption occurs from said optical time domain reflectometer;
a measured waveform data acquiring unit which accordingly acquires measured waveform data at a prescribed time interval from said optical time domain reflectometer;
a loss level calculating unit which calculates a loss level of said optical cable based on differential data between said reference waveform data and said measured waveform data;
an instantaneous interruption occurrence determining unit which determines the occurrence of an instantaneous interruption by comparing said loss level calculated by the loss level calculating unit and a threshold for determining instantaneous interruption stored in said measurement condition configuring table;
a measurement result recording unit which accordingly records a measurement result regarding said loss level on said measurement result recording table each time the instantaneous interruption occurrence determining unit determines whether an instantaneous interruption occurs or not;
an instantaneous interruption information recording unit which records instantaneous interruption information regarding said instantaneous interruption on said instantaneous interruption reporting table when said instantaneous interruption occurrence determining unit determines the occurrence of an instantaneous interruption; and
an instantaneous interruption occurrence reporting unit which reports the occurrence of an instantaneous interruption to a prescribed monitoring terminal based on said instantaneous interruption information recorded on said instantaneous interruption reporting table.

2. The instantaneous interruption monitoring system as set forth in claim 1, comprising:
a remaining capacity of a physical memory acquiring unit which acquires a remaining capacity of a physical memory incorporated in said instantaneous interruption monitoring system before supervision of an instantaneous interruption starts;
a physical memory remaining capacity determining unit which determines whether a remaining capacity of a physical memory acquired by the physical memory remaining capacity acquiring unit is insufficient or not;
a waveform data for self-diagnosis acquiring unit which acquires waveform data for self-diagnosis of the performance of said instantaneous interruption monitoring system from said optical time domain reflectometer before supervision of an instantaneous interruption starts;
a noise removal processing unit which removes a noise component of said waveform data for self-diagnosis using plural types of noise filters to remove a noise component of said differential data;
a measurement time calculating unit which calculates a measurement time obtained by adding a waveform data acquiring time required for acquiring said waveform data for self-diagnosis by said waveform data for self-diagnosis acquiring unit and a noise removing processing time required for removing a noise component of said waveform data for self-diagnosis by said noise removal processing unit for each of said noise filters;
a measurement time determining unit which determines whether a shortest measurement time of said measurement times exceeds a threshold for selecting noise filter for selecting said noise filter or not; and
a measurement condition changing unit which changes a measurement condition stored in said measurement condition configuring table when said physical memory remaining capacity determining unit determines that said physical memory remaining capacity is insufficient, or when said measurement time determining unit determines that said shortest measurement time exceeds said threshold for selecting noise filter.

3. The instantaneous interruption monitoring system as set forth in claim 2, comprising:
an instantaneous interruption number calculating unit which calculates an instantaneous interruption number from the start of supervision when said instantaneous interruption occurrence determining unit determines that an instantaneous interruption occurs;
an instantaneous interruption number determining unit which determines whether the instantaneous interruption number calculated by the instantaneous interruption number calculating unit is two or more, or not;
an instantaneous interruption occurrence point determining unit which determines whether a latest instantaneous interruption occurrence point is identical to a previous instantaneous interruption occurrence point or not when said instantaneous interruption number determining unit determines that said instantaneous interruption number is two or more;
an instantaneous interruption duration calculating unit which calculates an instantaneous interruption duration in which said instantaneous interruption continues when said instantaneous interruption occurrence point determining unit determines that a latest instantaneous interruption occurrence point is identical to a previous instantaneous interruption occurrence point;
an instantaneous interruption duration determining unit which determines whether the instantaneous interruption duration calculated by the instantaneous interruption duration calculating unit exceeds said threshold for selecting noise filter or not; and
a noise filter changing unit which changes a noise filter to a higher-order noise filter when said instantaneous interruption duration determining unit determines that said instantaneous interruption duration exceeds said threshold for selecting noise filter.

4. An instantaneous interruption monitoring program which monitors an instantaneous interruption that occurs in an optical cable using an optical time domain reflectometer connected to said optical cable, which allows a computer to function, comprising:
a software storing unit which stores the instantaneous interruption monitoring program and a non-real time operating system;
a memory unit in which a measurement condition configuring table and a measurement result recording table are mapped to a memory area controlled by said instantaneous interruption monitoring program and in which an instantaneous interruption reporting table is mapped to a memory area controlled by said non-real time operating system;
a reference waveform data acquiring unit which acquires reference waveform data at a status where no instantaneous interruption occurs from said optical time domain reflectometer;
a measured waveform data acquiring unit which accordingly acquires measured waveform data at a prescribed time interval from said optical time domain reflectometer;
a loss level calculating unit which calculates a loss level of said optical cable based on differential data between said reference waveform data and said measured waveform data;
an instantaneous interruption occurrence determining unit which determines the occurrence of an instantaneous interruption by comparing said loss level calculated by the loss level calculating unit and a threshold for determining instantaneous interruption stored in said measurement condition configuring table;
a measurement result recording unit which accordingly records a measurement result regarding said loss level on said measurement result recording table each time the instantaneous interruption occurrence determining unit determines whether an instantaneous interruption occurs or not;
an instantaneous interruption information recording unit which records instantaneous interruption information regarding said instantaneous interruption on said instantaneous interruption reporting table when said instantaneous interruption occurrence determining unit determines the occurrence of an instantaneous interruption; and
an instantaneous interruption occurrence reporting unit which reports the occurrence of an instantaneous interruption to a prescribed monitoring terminal based on said instantaneous interruption information recorded on said instantaneous interruption reporting table.

5. The instantaneous interruption monitoring program as set forth in claim 4, which allows a computer to function, comprising:
a remaining capacity of a physical memory acquiring unit which acquires a remaining capacity of a physical memory incorporated in said instantaneous interruption monitoring system before supervision of an instantaneous interruption starts;
a physical memory remaining capacity determining unit which determines whether a remaining capacity of a physical memory acquired by the physical memory remaining capacity acquiring unit is insufficient or not;
a waveform data for self-diagnosis acquiring unit which acquires waveform data for self-diagnosis of the performance of said instantaneous interruption monitoring system from said optical time domain reflectometer before supervision of an instantaneous interruption starts;
a noise removal processing unit which removes a noise component of said waveform data for self-diagnosis using plural types of noise filters to remove a noise component of said differential data;
a measurement time calculating unit which calculates a measurement time obtained by adding a waveform data acquiring time required for acquiring said waveform data for self-diagnosis by said waveform data for self-diagnosis acquiring unit and a noise removing processing time required for removing a noise component of said waveform data for self-diagnosis by said noise removal processing unit for each of said noise filters;
a measurement time determining unit which determines whether a shortest measurement time of said measurement times exceeds a threshold for selecting noise filter for selecting said noise filter or not; and
a measurement condition changing unit which changes a measurement condition stored in said measurement condition configuring table when said physical memory remaining capacity determining unit determines that said physical memory remaining capacity is insufficient, or when said measurement time determining unit determines that said shortest measurement time exceeds said threshold for selecting noise filter.

6. The instantaneous interruption monitoring program as set forth in claim 5, which allows a computer to function, comprising:
an instantaneous interruption number calculating unit which calculates an instantaneous interruption number from the start of supervision when said instantaneous interruption occurrence determining unit determines that an instantaneous interruption occurs;
an instantaneous interruption number determining unit which determines whether the instantaneous interruption number calculated by the instantaneous interruption number calculating unit is two or more, or not;
an instantaneous interruption occurrence point determining unit which determines whether a latest instantaneous interruption occurrence point is identical to a previous instantaneous interruption occurrence point or not when said instantaneous interruption number determining unit determines that said instantaneous interruption number is two or more;
an instantaneous interruption duration calculating unit which calculates an instantaneous interruption duration in which said instantaneous interruption continues when said instantaneous interruption occurrence point determining unit determines that a latest instantaneous interruption occurrence point is identical to a previous instantaneous interruption occurrence point;
an instantaneous interruption duration determining unit which determines whether the instantaneous interruption duration calculated by the instantaneous interruption duration calculating unit exceeds said threshold for selecting noise filter or not; and
a noise filter changing unit which changes a noise filter to a higher-order noise filter when said instantaneous interruption duration determining unit determines that said instantaneous interruption duration exceeds said threshold for selecting noise filter.
